(19) United States
(12) Patent Application Publication
(10) Pub. No.: US 2026/0341980 A1
(43) Pub. Date: Oct. 29, 2026

(54) BONDING STUD

(71) Applicant: PACCAR Inc, Bellevue, WA (US)

(72) Inventor: Daniel Richards, Bellevue, WA (US)

(21) Appl. No.: 19/192,990

(22) Filed: Apr. 29, 2025

(51) Int. Cl. H01R 4/34

(52) U.S. Cl. CPC H01R 4/34

(57) ABSTRACT

A bonding stud configured to equalize electrical potential between two separated components is disclosed and may include a head portion, a threaded rod configured to receive a threaded nut to secure the bonding stud to a component having a bonding stud aperture formed therein, a tapered knurled shoulder positioned between the head portion and the threaded rod, and at least one bonding tether extension extending from one of opposing ends of the bonding stud. The tapered knurled shoulder may have a diameter adjacent to the head portion that is larger than a diameter of the tapered knurled shoulder adjacent to the threaded rod such that the tapered knurled shoulder tapers in a direction away from the head portion. The tapered knurled shoulder may be configured to wedge into and intimately contact material of the component surrounding the bonding stud aperture when the threaded nut is tightened during use to secure the bonding stud to the component.

### BACKGROUND

### Technical Field

The present disclosure relates generally to an electrical bonding stud, and more particularly, to an electrical bonding stud for use with a high voltage electrical component.

### Description of the Related Art

Electrical bonding is known for use in systems having high voltage components. Electrical bonding connects a high voltage component with another metal component to reduce the difference in electrical potential between the high voltage component and the metal component. Electrical bonding reduces the risk of electric shock to a person touching both components. Electrical bonding is common in electrical vehicles, which may couple high voltage components thereof (e.g., a high voltage battery) with a frame or chassis of the vehicle.

Bonding studs are commonly used to create an electrical connection with a metal component of an electrical bonding system, such as the frame of an electric vehicle. Bonding studs may be installed in an aperture in the metal component of the electric vehicle. However, such apertures may not be properly sized for and/or aligned with the bonding stud, which may create a poor electrical path between the bonding stud and the metal component. For example, the bonding stud may include a square connection portion, but the aperture of the metal component of the electrical vehicle may not be exactly square, for example due to tool wear of a tool used to form the aperture. The poor electrical path may reduce the benefit of the electrical bonding system and may cause additional electrical safety hazards.

### BRIEF SUMMARY

Embodiments described herein include electrical bonding systems having a bonding stud that is configured to improve the electrical connection or path between the bonding stud and a component of the electrical bonding system. Such embodiments may improve the reliability of electrical bonding systems and may reduce the risk of electric shock to one in the vicinity of a vehicle housing the electrical bonding system, for example.

The bonding stud may include a head portion, a threaded rod, a tapered knurled shoulder positioned between the head portion and the threaded rod, and at least one bonding tether extension extending from one of opposing ends of the bonding stud. The threaded rod may be configured to receive a threaded nut to secure the bonding stud to a component having a bonding stud aperture formed therein, such as, for example, a punched hole having a circular profile. The tapered knurled shoulder may have a diameter adjacent to the head portion that is larger than a diameter of the tapered knurled shoulder adjacent to the threaded rod such that the tapered knurled shoulder tapers in a direction away from the head portion. The tapered knurled shoulder may be configured to wedge or bite into and intimately contact material of the component surrounding the bonding stud aperture when the threaded nut is tightened during use to secure the bonding stud to the component. The at least one bonding tether extension may extend from the head portion at one end of the bonding stud and/or from the threaded rod at the other end of the bonding stud. The at least one bonding tether extension may be a threaded structure. The threaded rod of the bonding stud may have a major diameter that is equal to or smaller than the diameter of the tapered knurled shoulder adjacent the threaded rod.

An electrical balancing system for balancing electrical potential between two separated components disclosed herein may include the aforementioned bonding stud, a first one of the separated components including a bonding stud aperture formed therein, a threaded nut configured to be received on the threaded rod to secure the bonding stud to the first one of the separated components when the bonding stud is received in the bonding stud aperture of the first one of the separated components, a second one of the separated components, and a bonding tether having a first end and a second end. The bonding stud aperture may be configured to receive the bonding stud therethrough and at least a portion of the tapered knurled shoulder therein. In some instances, the bonding stud aperture may be a punched hole having a circular profile and the sidewalls defining the bonding stud aperture may not be vertical. The tapered knurled shoulder is configured to create an electrical connection or path between the bonding stud and the first one of the separated components characterized by relatively low impedance. The first end of the bonding tether may be coupled to a first bonding tether extension of the at least one bonding tether extension of the bonding stud and the second end of the bonding tether may be coupled to the second one of the separated components. The bonding stud aperture of the first one of the separate components may be tapered in the same direction as the bonding stud and to a similar or same degree. One of the separated components may be a rail of a chassis of a vehicle. One of the separated components may be a high voltage electrical component of a vehicle.

Among other benefits, aspects of the embodiments disclosed herein may provide improved electrical connections in electrical bonding systems and may improve the ease of installation of electrical bonding systems.

### BRIEF DESCRIPTION OF THE SEVERAL VIEWS OF THE DRAWINGS

FIG. 1 shows a perspective view of an example embodiment of an electrical bonding system according to the present disclosure.

FIG. 2 shows a perspective view of an example embodiment of a bonding stud according to the present disclosure.

FIG. 3 shows a cross-sectional side view of the bonding stud of FIG. 2.

FIG. 4 shows a bottom view of the bonding stud of FIG. 2.

FIG. 5 shows a perspective view of another exemplary bonding stud according to the present disclosure.

FIG. 6 shows a cross-sectional view of a portion of the electrical bonding system of FIG. 1.

### DETAILED DESCRIPTION

In the following description, certain specific details are set forth in order to provide a thorough understanding of various disclosed embodiments. However, one of ordinary skill in the relevant art will recognize that embodiments may be practiced without one or more of these specific details. In other instances, well-known structures and techniques associated with electrical bonding systems may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

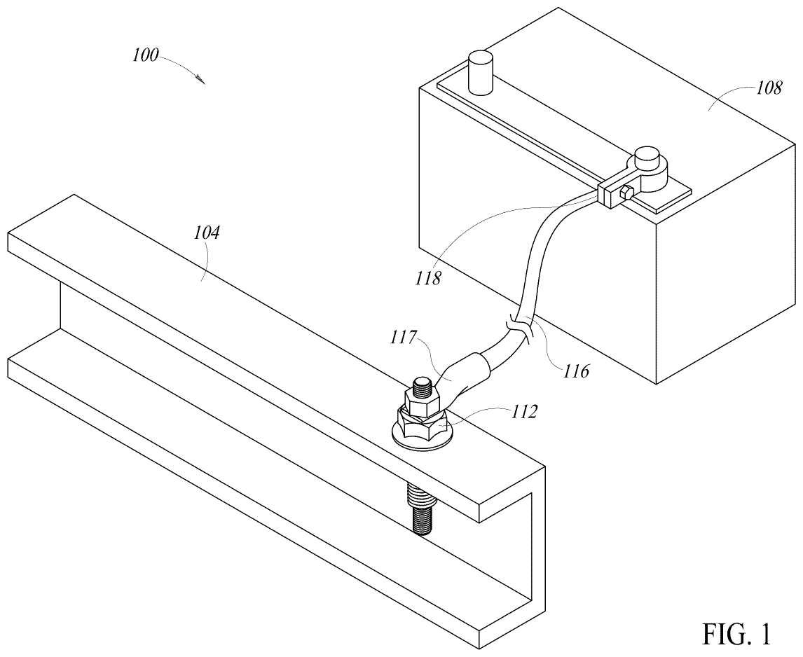

FIG. 1 shows an example embodiment of an electrical bonding system 100 in use in an electric vehicle according to the present disclosure. The electrical bonding system 100 includes a first separated component 104, a second separated component 108, a bonding stud 112 coupled to the first separated component 104, and a bonding tether 116 coupled to the bonding stud 112 and the second separated component 108. The electrical bonding system 100 may be present in a motor vehicle. Specifically, the electrical bonding system 100 may be present in an electric vehicle. The electrical bonding system 100 is configured to electrically balance the first and second separated components 104, 108 (i.e., reduce the electrical potential difference therebetween). The electrical balancing provides improved safety to a person making contact with the electrical vehicle by reducing the possibility of an electric shock occurring.

In the example embodiment shown in FIG. 1, the first separated component 104 may be a metal frame of the electric vehicle. The second separated component 108 may be a high voltage battery of the electric vehicle. In such an embodiment, the first separated component 104 and the second separated component 108 may have a difference in electrical potential. It should be understood that the first separated component 104 and the second separated component 108 may instead be other components of the electric vehicle that have a difference in electrical potential. One of the first and second separated components 104, 108 may comprise a high voltage component, such as a battery, a power control and accessory system (PCAS), an electric motor, an e-axle, or a central drive unit. The other of the first and second separated components 104, 108 may be a metal component, such as a metal structural component, and does not comprise a high voltage component.

The bonding tether 116 comprises an electrically conductive material, such that the bonding tether 116 may conduct electricity from a first end 117 thereof to a second end 118 thereof. The first end 117 of the bonding tether 116 may couple to the bonding stud 112. The second end 118 of the bonding tether 116 may couple to the second separated component 108, such as, for example, to a terminal or terminal extension of a battery.

The bonding stud 112 and the bonding tether 116 electrically couple the first separated component 104 and the second separated component 108 to enable the first separated component 104 and the second separated component 108 to have the same electrical potential. The connection between the bonding stud 112 and the first separated component 104 is critical to ensuring the difference in electrical potential between the first separated component 104 and the second separated component 108 is reduced. The bonding stud 112 disclosed herein is configured to improve reliability of the electrical coupling of the bonding stud 112 and the first separated component 104.

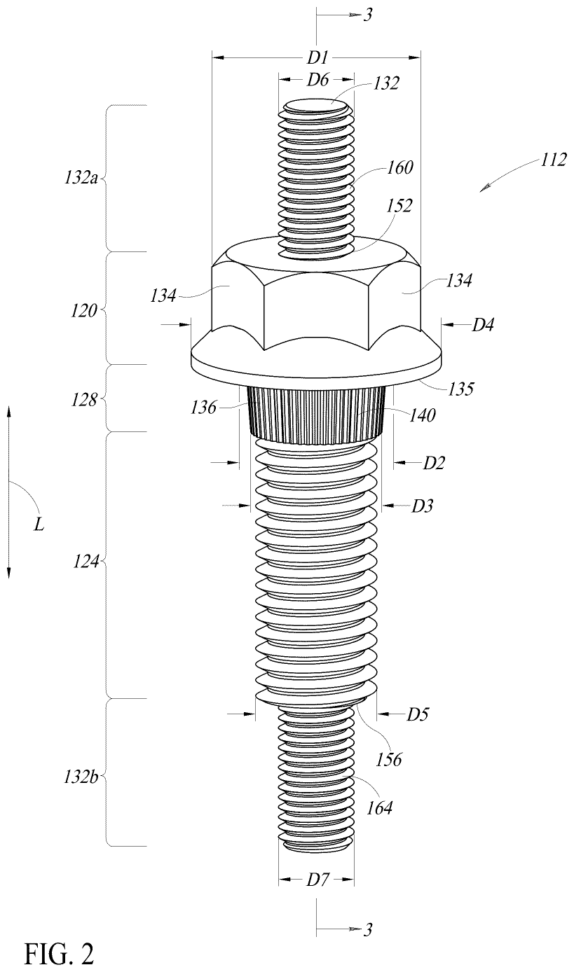

FIGS. 2 through 4 show the bonding stud 112 which is configured to couple to the first separated component 104. The bonding stud 112 may comprise a head portion 120, a threaded rod 124, a tapered knurled shoulder 128, and at least one bonding tether extension 132a, 132b.

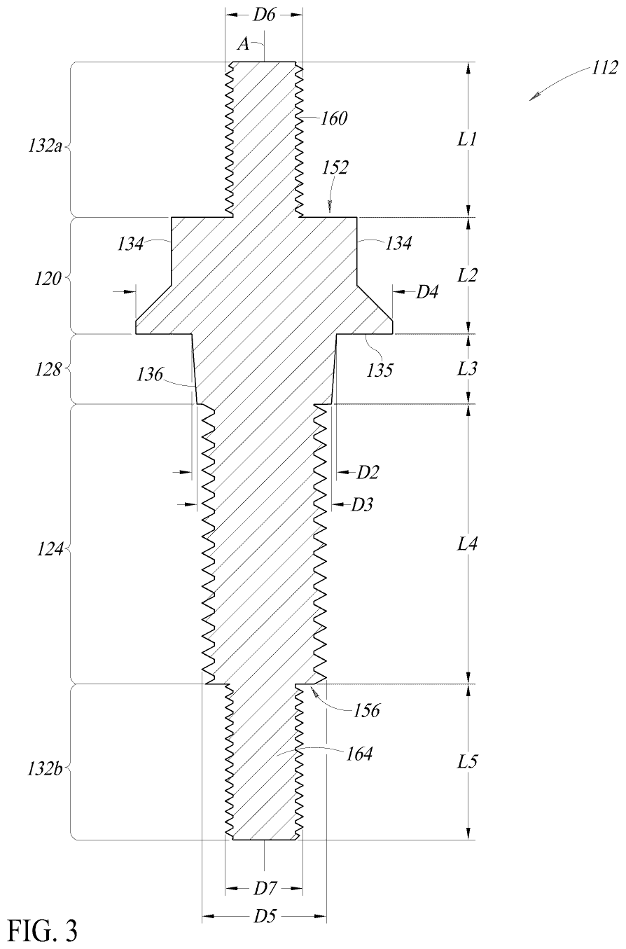

The head portion 120 may be configured to be engaged by a tightening tool, such as, a wrench. For instance, the head portion 120 may be configured similarly to a head of a standard bolt with a hexagonal body portion with flat side faces 134 configured to engage with standard SAE or metric sized sockets of a wrench. With reference to FIG. 3, the head portion includes a head diameter D1, associated with a circle circumscribing opposing corners of the flat side faces 134 of the head portion 120. The threaded rod 124 may be configured to receive a threaded nut thereon to secure the bonding stud 112 to a component of the electrical bonding system, such as the first separated component 104. The threaded rod 124 includes threads extending along at least a portion of the threaded rod 124. In some instances, a portion of the threaded rod 124 may lack threads so that the threaded rod 124 is only partially threaded. In other instances, an entirety or nearly an entirety of the threaded rod 124 may be threaded, as shown, for example, in the embodiment of the bonding stud 112 shown in FIGS. 2 through 4.

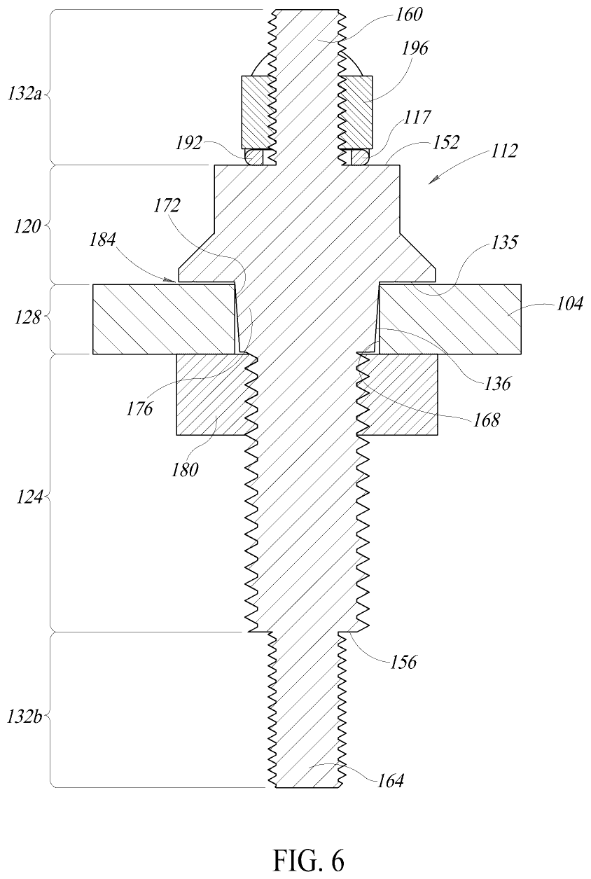

The tapered knurled shoulder 128 is positioned between a shoulder side 135 of the head portion 120 and the threaded rod 124. With reference to FIG. 3, the tapered knurled shoulder 128 includes a base diameter D2 adjacent to the head portion 120 and a rod diameter D3 adjacent to the threaded rod 124. The base diameter D2 is larger than the rod diameter D3, as shown in FIG. 3. In other words, the tapered knurled shoulder 128 tapers inwardly in a direction away from the head portion 120. Additionally, a shoulder diameter D4 of the shoulder side 135 of the head portion 120 may be larger than the base diameter D2 of the tapered knurled shoulder. The shoulder diameter D4 may be of sufficient size to prevent the head portion 120 from being received in an aperture in which the tapered knurled shoulder 128 is received, such as the aperture 168 discussed below with reference to FIG. 6.

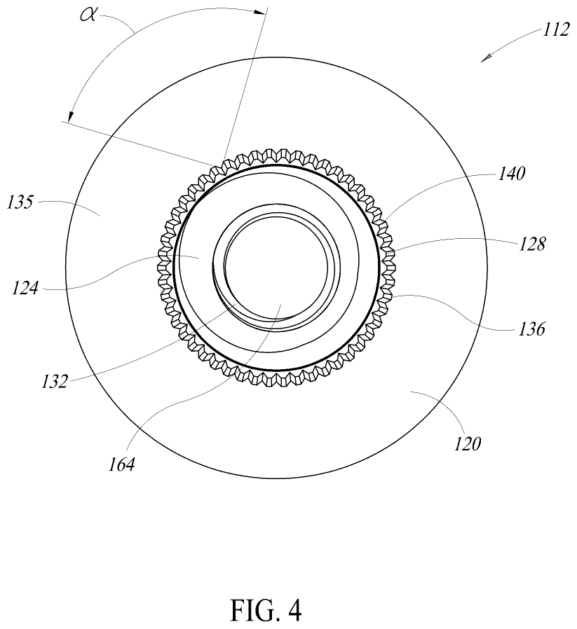

The tapered knurled shoulder 128 may include straight knurls 136 extending radially outward on an exterior 140 of the tapered knurled shoulder 128, as shown in FIG. 2. The straight knurls 136 may extend along an entirety of the tapered knurled shoulder 128 in a longitudinal direction L parallel to a longitudinal axis A of the bonding stud 112. As shown in FIG. 4, the straight knurls 136 may have a tooth angle α of 90°. In some embodiments, the straight knurls 136 may have a tooth angle α1 of 90°±2° although other angles are contemplated. With reference again to FIG. 3, the threads of the threaded rod 124 have a major diameter D5 that is equal to or smaller than the rod diameter D3 of the tapered knurled shoulder 128.

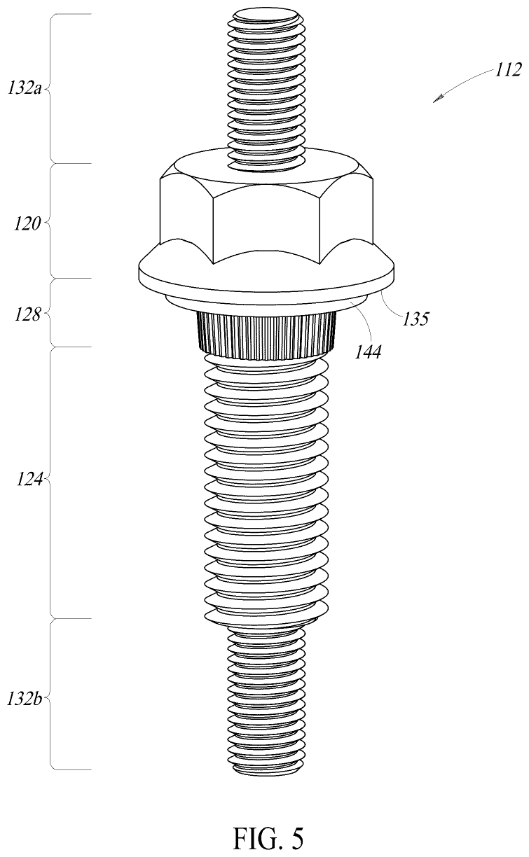

In some embodiments, an intermediate structure, such as, for example, a washer or a foam liner 144 may abut the shoulder side 135 of the head portion 120 and encircle a portion of the tapered knurled shoulder 128. The foam liner 144 may be positioned between the shoulder side 135 of the head portion 120 and the first separated component 104 when installed therein. An example embodiment including the foam liner 144 of the bonding stud 112 is shown in FIG. 5.

Returning to FIGS. 2 through 4, each of the at least one bonding tether extensions 132a, 132b extends from one of opposing ends 152, 156 of the bonding stud 112. The at least one bonding tether extension 132a, 132b may include two bonding tether extensions 160, 164. A head bonding tether extension 160 of the at least one bonding tether extension 132a, 132b may extend from the head portion 120 on the head end 152 of the bonding stud 112. A rod bonding tether extension 164 of the at least one bonding tether extension 132a, 132b may extend from the threaded rod 124 on the rod end 156 of the bonding stud 112. Only one of the head bonding tether extension 160 and the rod bonding tether extension 164 may be present, or both of the head bonding tether extension 160 and the rod bonding tether extension 164 may be present.

The at least one bonding tether extension 132 may be a threaded structure configured to receive a nut thereon. A maximum diameter D6, D7 of the threads of the at least one bonding tether extension 132a, 132b may be smaller than the head diameter D1 of the head portion, and in some instances, may be smaller than the major diameter D5 of the threaded rod 124.

Representative dimensions of an example embodiment of a bonding stud is provided in the table below. The provided dimensions are merely an example and are non-limiting. It is appreciated that the dimensions may be proportionally scaled in embodiments to be utilized with corresponding stud receiving apertures 168 of different sizes. It is further appreciated that for any specific implementation, the bonding stud 112 and stud receiving aperture 168 with be of correlated sizes to enable the functionality herein. That is the stud-receiving aperture 168 will be sized to receive a correspondingly sized bonding stud 112 such that the tapered knurled shoulder 128 of the bonding stud 112 may be drawn into intimate engagement with the material defining the stud-receiving aperture 168 during installation. The representative dimensions may have tolerances of ±0.1 mm or ±0.2 mm or larger.

TABLE

| Dimension | Example Size | |
|---|---|---|
| D1 | 27.5 | mm |
| D2 | 18.6 | mm |
| D3 | 17.3 | mm |
| D4 | 33.0 | mm |
| D5 | 16.0 | mm |
| D6 | 10.0 | mm |
| D7 | 10.0 | mm |
| L1 | 20.0 | mm |
| L2 | 15.0 | mm |
| L3 | 9.0 | mm |
| L4 | 36.0 | mm |
| L5 | 20.0 | mm |

The bonding stud 112 may comprise steel and/or zinc or other suitable material(s) for the applications disclosed herein. Specifically, the bonding stud 112 may comprise a steel core and a zinc metal plated finish. The bonding stud may be configured such that at least one of the tapered knurled shoulder 128 and the first separated component 104 to which the bonding stud 112 is directly coupled is deformed during coupling of the bonding stud 112 to the first separated component 104. In some embodiments, the tapered knurled shoulder 128 may be configured to comprise a material that is softer than a material of the first separated component 104 to which the bonding stud 112 is directly coupled. In other embodiments, the tapered knurled shoulder 128 may be configured to comprise a material that is harder than the material of the first separated component 104 to which the bonding stud 112 is directly coupled. In other embodiments, the tapered knurled shoulder 128 may be configured to comprise a material that is the same or about the same hardness as the material of the first separated component 104 to which the bonding stud 112 is directly coupled.

A cross-section of the bonding stud 112 and the first separated component 104 when coupled together is shown in FIG. 6. The first separated component 104 of the electrical bonding system 100 includes a bonding stud aperture 168 formed therein, such as, for example, by a punch process or other suitable manufacturing process. Although the bonding stud aperture 168 shown in FIG. 6 is illustrated with straight exterior walls 172, the exterior walls 172 of the bonding stud aperture 168 may be tapered, curvilinear, or otherwise regularly or irregularly shaped. For instance, the exterior walls 172 of the bonding stud aperture 168 may be tapered in the same direction as the tapered knurled shoulder 128 of the bonding stud 112 and to a similar or a same degree. The bonding stud aperture 168 is configured to receive the bonding stud 112 therethrough regardless of minor variations in the shape of the exterior walls 172 thereof. Specifically, at least a portion 176 of the tapered knurled shoulder 128 may be received in the bonding stud aperture 168.

The tapered knurled shoulder 128 is configured to wedge or bite into and intimately contact material of the first separated component 104 on the exterior walls 172 of the bonding stud aperture 168. The tapered shape of the tapered knurled shoulder 128 may enable the tapered knurled shoulder 128 to intimately contact material of the first separated component 104 on the exterior walls 172 of the bonding stud aperture 168 in embodiments in which the exterior walls 172 of the bonding stud aperture 168 are not uniformly straight. The bonding stud 112 may be securely coupled to the first separated component 104 by way of a threaded nut 180 threaded onto the threaded rod 124. In some embodiments, including the embodiment shown in FIG. 6, the bonding stud 112 may be securely coupled to the first separated component 104 with a gap 184 present between the shoulder side 135 of the head portion 120 of the bonding stud 112 and the first separated component 104. In such embodiments, the intimate contact between the tapered knurled shoulder 128 and the exterior walls 172 of the bonding stud aperture 168 securely couples the bonding stud 112 to the first separated component 104 in combination with the tightened threaded nut 180 on the threaded rod 124. In other embodiments, the threaded nut 180 may be tightened until the shoulder side 135 of the head portion 120 of the bonding stud 112 contacts the first separated component 104.

Coupling of the bonding tether 116 to the bonding stud 112 is shown in FIG. 6. The first end 117 of the bonding tether 116 may include a terminal 192 configured to be received on the bonding tether extension 132a. In some embodiments, a threaded nut 196 may be threaded onto the bonding tether extension 132a to electrically couple the terminal 192 to the bonding stud 112. In some embodiments, the terminal 192 may include internal threads configured to be threaded onto the bonding tether extension 132a. In embodiments which include a plurality of bonding tether extensions 132a, 132b present on the bonding stud 112, such as the illustrated embodiment in FIG. 6, the first end 117 of the bonding tether 116 may be coupled to either the head bonding tether extension 160 or the rod bonding tether extension 164. The inclusion of both bonding tether extensions 160, 164 enables an installer of the electrical bonding system 100 to couple the first end 117 of the bonding tether 116 to the closer bonding tether extension 132 and/or the bonding tether extension 132 which is easier to access. In some instances, a respective bonding tether 116 may be secured to each of the opposing bonding tether extensions 132a, 132b.

With reference back to FIG. 1, the second end 118 of the bonding tether 116 is electrically coupled to the second separated component 108, as shown in FIG. 1. The second end 118 of the bonding tether 116 may be coupled to the second separated component 108 by way of any suitable fastening method, including, for example, a threaded nut, a threaded collar, or a lug. The electrical connection from the second separated component 108, through the bonding tether 116 and the bonding stud 112, and to the first separated component 104 may reduce the difference in electrical potential between the first separated component 104 and the second separated component 108 as previously discussed.

A method of creating an electrical connection for balancing electrical potential between the first and second separated components is described below with reference to FIGS. 1 through 4 and 6.

To begin, the bonding stud 112 is inserted into the bonding stud aperture 168. The bonding stud may be installed in the orientation shown in FIG. 6, or in an opposite orientation (i.e., wherein the bonding stud 112 is rotated 180 degrees). Such flexibility may enable an installer to more efficiently and more easily install the bonding stud 112.

During insertion of the bonding stud 112 into the bonding stud aperture 168, a threaded nut 180 may be positioned and threaded onto the threaded rod 124 to secure the bonding stud 112 to the first separated component 104. As the threaded nut 180 is tightened (e.g., by way of applying a torque to the threaded nut 180 and/or the head portion 120 of the bonding stud 112), the tapered knurled shoulder 128 is drawn into the bonding stud aperture 168 such that the tapered knurled shoulder 128 contacts the exterior walls 172 of the bonding stud aperture. During further tightening of the threaded nut 180 on the threaded rod 124, the straight knurls 136 of the tapered knurled shoulder 128 intimately contact the exterior walls 172 of the bonding stud aperture 168. It is possible for the straight knurls 136 to be partially embedded in the exterior walls 172 of the bonding stud aperture 168 by way of tightening of the threaded nut 180 on the threaded rod 124 and/or for the straight knurls 136 and surrounding material of the exterior walls 172 to deform. During such tightening, material of the straight knurls 136 may be partially eroded by contact with the exterior walls 172 of the bonding stud aperture 168 to create further intimate contact between the tapered knurled shoulder 128 and the external walls 172 of the bonding stud aperture 168. The intimate contact between the tapered knurled shoulder 128 and the external walls 172 of the bonding stud aperture 168 may create a particularly reliable electrical connection or path therebetween that is characterized by a relatively low impedance.

Next, the first end 117 of the bonding tether 116 may be coupled to a bonding tether extension 132a, 132b of the bonding stud 112. For example, the threaded nut 196 may be fastened to the bonding tether extension 132a, 132b thereby coupling the terminal 192 of the first end 117 of the bonding tether 116 to the bonding stud 112. The second end 118 of the bonding tether 116 may be coupled to the second separated component 108 before or after the coupling of the first end 117 to the bonding stud 112 which is in intimate contact with the first separated component 104. Following such connections, the difference in electrical potential between the first separated component 104 and the second separated component 108 will be reduced.

The bonding stud and associated systems described herein may be adapted to a variety of implementations including high voltage components, including those related to and not related to electric vehicles. Such bonding studs may provide improved electrical connections in electrical bonding systems and may provide safer environments to those working on in the vicinity of such systems.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the relevant art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A bonding stud configured to equalize electrical potential between two separated components, the bonding stud comprising:
a head portion;
a threaded rod configured to receive a threaded nut to secure the bonding stud to a component having a bonding stud aperture formed therein;
a tapered knurled shoulder positioned between the head portion and the threaded rod, the tapered knurled shoulder having a diameter adjacent to the head portion that is larger than a diameter of the tapered knurled shoulder adjacent to the threaded rod such that the tapered knurled shoulder tapers in a direction away from the head portion, and such that the tapered knurled shoulder is configured to wedge into and intimately contact material of the component surrounding the bonding stud aperture when the threaded nut is tightened during use to secure the bonding stud to the component; and
at least one bonding tether extension extending from one of opposing ends of the bonding stud.

2. The bonding stud of claim 1, wherein the at least one bonding tether extension extends from the head portion at one end of the bonding stud or from the threaded rod at the other end of the bonding stud.

3. The bonding stud of claim 1, wherein the at least one bonding tether extension comprises a first bonding tether extension that extends from one of the opposing ends of the bonding stud and a second bonding tether extension that extends from the other one of the opposing ends of the bonding stud.

4. The bonding stud of claim 1, wherein the at least one bonding tether extension is a threaded structure.

5. The bonding stud of claim 1, wherein the tapered knurled shoulder is configured to deform when the bonding stud is secured to the component having the bonding stud aperture formed therein, and/or wherein the tapered knurled shoulder is configured to cause the component having the bonding stud aperture formed therein to deform when the bonding stud is secured to the component.

6. (canceled)

7. The bonding stud of claim 1, wherein the threaded rod of the bonding stud has a major diameter that is equal to or smaller than the diameter of the tapered knurled shoulder adjacent the threaded rod.

8. The bonding stud of claim 1, wherein the tapered knurled shoulder includes straight knurls extending radially outward on the tapered knurled shoulder, and wherein the straight knurls have a tooth angle of 90°±2°.

9. (canceled)

10. An electrical balancing system for balancing electrical potential between two separated components, the electrical balancing system comprising:
a bonding stud, including:
a head portion;
a threaded rod;
a tapered knurled shoulder positioned between the head portion and the threaded rod, the tapered knurled shoulder having a diameter adjacent to the head portion that is larger than a diameter of the tapered knurled shoulder adjacent to the threaded rod such that the tapered knurled shoulder tapers in a direction away from the head portion; and
at least one bonding tether extension extending from one of opposing ends of the bonding stud;
a first one of the separated components including a bonding stud aperture formed therein, the bonding stud aperture configured to receive the bonding stud therethrough and at least a portion of the tapered knurled shoulder therein;
a threaded nut configured to be received on the threaded rod to secure the bonding stud to the first one of the separated components when the bonding stud is received in the bonding stud aperture of the first one of the separated components;
a second one of the separated components; and
a bonding tether having a first end and a second end,
wherein the tapered knurled shoulder is configured to wedge into and intimately contact material of the first one of the separated components surrounding the bonding stud aperture when the threaded nut is tightened during use to secure the bonding stud to the first one of the separated components such that an electrical connection is created between the bonding stud and the first one of the separated components, and
wherein the first end of the bonding tether is coupled to a first bonding tether extension of the at least one bonding tether extension of the bonding stud and the second end of the bonding tether is coupled to the second one of the separated components.

11. The electrical balancing system of claim 10, wherein the tapered knurled shoulder of the bonding stud is configured to deform when the bonding stud is secured to the first one of the separated components, and/or wherein the first one of the separated components is configured to deform when the bonding stud is secured to the first one of the separated components.

12. The electrical balancing system of claim 11, wherein the bonding stud aperture is tapered in a direction corresponding to that of the tapered knurled shoulder of the bonding stud.

13. The electrical balancing system of claim 10, wherein the threaded rod of the bonding stud has a major diameter that is equal to or smaller than the diameter of the tapered knurled shoulder adjacent the threaded rod.

14. The electrical balancing system of claim 10, wherein the at least one bonding tether extension comprises a first bonding tether extension that extends from one of the opposing ends of the bonding stud and a second bonding tether extension that extends from the other one of the opposing ends of the bonding stud.

15. The electrical balancing system of claim 10, wherein the at least one bonding tether extension is a threaded structure.

16. The electrical balancing system of claim 10, wherein the tapered knurled shoulder of the bonding stud includes straight knurls extending radially outward on the tapered knurled shoulder, wherein the straight knurls have a tooth angle of 90°±2°.

17. (canceled)

18. (canceled)

19. The electrical balancing system of claim 10, wherein one of the separated components is a rail of a chassis of a vehicle.

20. The electrical balancing system of claim 10, wherein one of the separated components is a high voltage electrical component of a vehicle.

21. A method of creating an electrical connection for balancing electrical potential between two separated components, the method comprising:
coupling a bonding stud to a first one of the separated components by way of a threaded rod of the bonding stud and an associated threaded nut, whereby a tapered knurled shoulder of the bonding stud is urged into intimate contact with a material of the first one of the separated components to create an electrical connection between the bonding stud and the first one of the separated components;
coupling one of opposing ends of a bonding tether to a bonding tether extension extending from an end of the bonding stud; and
coupling the other one of opposing ends of the bonding tether to a second one of the separated components.

22. The method of claim 21, further comprising:
receiving the bonding stud through a tapered aperture extending through the first one of the separated components prior to coupling of the bonding stud and the first one of the separated components by way of the threaded rod and the associated threaded nut.

23. (canceled)

24. The method of claim 21, wherein the tapered knurled shoulder is configured to deform when the bonding stud is secured to the first one of the separated components, and/or wherein the first one of the separated components is configured to deform when the bonding stud is secured to the first one of the separated components.

25. The method of claim 21, wherein the bonding tether extension extends from a head portion of the bonding stud or from the threaded rod of the bonding stud.

26. (canceled)
